(19) United States
(12) Patent Application Publication
(10) Pub. No.: US 2016/0185934 A1
(43) Pub. Date: Jun. 30, 2016

(54) IMPROVED NATURAL RUBBER COMPOSITIONS

(71) Applicant: AMRIL AG, Zug (CH)

(72) Inventors: Surina Ismail, Kuala Lumpur (MY); Azemi Bin Samsuri, Selangor Darul Ehsan (MY)

(21) Appl. No.: 14/908,792

(22) PCT Filed: Aug. 30, 2013
(86) PCT No.: PCT/IB2013/058143

§ 371 Date: Jan. 29, 2016

(51) Int. Cl. C08K 3/04; C08K 3/00; C08K 5/00

(52) U.S. Cl. CPC C08K 3/04; C08K 5/0025; C08K 5/005; C08K 3/0041; C08K 3/0016

(57) ABSTRACT

There is herein described improved natural rubber compositions for use in engineered rubber products for use in civil and mechanical engineering applications having nanocarbon and carbon black as reinforcing agents wherein the nanocarbon is uniformly pre-dispersed within the rubber component. In particular there is described rubber compositions comprising a mixture of natural rubber, nanocarbon and carbon black wherein the relative amount in parts per hundred rubber (pphr) of nanocarbon to carbon black is in the range of about 1:40 to about 1:2 and the relative amount in parts per hundred rubber (pphr) of nanocarbon to natural rubber is in the range of about 1:100 to about 10:100 and wherein the nanocarbon component is pre-dispersed within the natural rubber component.

### FIELD OF THE INVENTION

The present invention relates to improved natural rubber compositions for use in engineered rubber products for civil and mechanical engineering applications. More particularly, the present invention relates to improved natural rubber compositions for use in engineered rubber products for civil and mechanical engineering applications having nanocarbon and carbon black as reinforcing agents wherein the nanocarbon is uniformly pre-dispersed within the rubber component of said compositions.

### BACKGROUND OF THE INVENTION

The rubber industry is the second largest industry in the world after iron and steel, with 92% of global supplies of natural rubber from Asia. In a recent report the size of the world market for non-tire rubber products is estimated at $90 billion per annum, with developing nations like China, India and Brazil, showing an increasing trend in per capita consumption of raw rubber shows highlighting an increased global demand for all kinds of Natural Rubber (NR) goods. Given the extensive use of rubber bearings in civil and mechanical engineering applications there is an estimated increased demand for such products particularly in the developing nations where the relative volume and scale of such engineering projects are presently high and are anticipated to continue increasing.

Rubbers are widely used in civil and mechanical engineering applications, such as rubber bridge bearings, earthquake and seismic bearings, vibration isolators and dampers, marine fendering systems and many others. Natural rubber (NR) in particular has been used extensively in engineering applications for over 150 years. The suitability of NR for engineering applications is associated with its unique physical properties including: a high bulk modulus (2000 to 3000 MPa) relative to Young's modulus (0.5 to 3.0 MPa); inherent damping effects; and desirable strain deformation properties.

The bulk modulus of the material influences the amount of volume changes during deformation. Rubbers having high bulk modulus hardly change their volume when deformed. In simple terms, rubber is incompressible, and like incompressible liquids, has a Poisson's ratio close to 0.5. If rubber is constrained, to prevent changes in shape, it becomes much stiffer, a feature which is advantageously used in the design of rubber compression springs. Rubber bridge bearings and seismic bearings in particular, are examples of products which rely on these properties.

A particular advantage of seismic rubber bearings is their ability to provide dual protection giving maximum protection not only to the buildings but also to the people and contents inside. The effectiveness of these rubber bearings was clearly demonstrated during the 1994 Northridge and 1995 Kobe devastating earthquakes during which buildings and bridges installed with rubber bearings out-performed conventionally-built structures. Such rubber bearings are increasingly in demand in earthquake-prone areas, for example more than 8,000 seismic rubber bearings were used for more than 150 blocks of building apartment of 8 and 12-storey high in the Parand project, in Iran, this followed an earthquake in 2003 where the historical city of Bam was destroyed. However, in the civil engineering field in particular there is a long-established desire for lighter bearings which can still deliver the required strength and hardness. Thus it would be desirable to provide lighter engineered rubber products for use in civil and mechanical engineering applications which retain the protective abilities of seismic bearings.

In parallel, the inherent damping properties of rubber are valuable in compression springs because they help prevent the amplitude of vibration from becoming excessive when/if resonant frequencies are encountered. Rubber products such as vibration isolators, bearings, and engine mounts rely on the desirable inherent damping properties of rubber.

The ability of rubber to undergo large strain deformation (a few hundred percent) without failure, means that it can store much more energy per unit volume than steel. This property is exploited in applications which utilize both the static and dynamic characteristics of rubber, such as for example in rubber dock and marine fender systems where the large stored energy capacity of the rubber absorbs shocks, and blows as well as the impact exerted by ships.

With the ever increasing demand for rubber products, one of the challenges for the rubber industry is the provision of materials able to satisfy the varied and complex needs within the civil and mechanical engineering and mining fields. In particular, where thicker elastomeric composite rubber products are produced, such as for utility in seismic bearings, docking or marine fendering systems, or rubber bridge bearings, the balance between time to on-set of curing (t2) and the optimum cure time (t95) are especially important. Preservation of the integrity of the properties of the rubber throughout the curing process is important, because should reversion occur, then the strength of the product is compromised. Thus it would be desirable to provide engineered rubber products having improved on-set, longer (t2) and longer cure time (t95).

An additional challenge for manufacturers of engineered rubber products for utility in the civil and mechanical engineering fields is the provision of products which not only have the necessary physical properties such as strength, compression, absorption to meet the needs of their particular end-function, but also, are able to maintain their functionality during the intended life cycle for a given product i.e. that the products demonstrate aging resistance. Thus it would be desirable to provide engineered rubber products for use in civil and mechanical engineering applications having improved aging resistance.

Following the discovery of nanosized carbon structures, also referred to as nanocarbon/nanotubes, and their unique combination of extraordinary strength, for example tensile strength greater than steel but with only one sixth of its weight, there has been great interest in using such materials, such as for example carbon nanotubes (CNTs) also sometimes referred to as buckytubes which are allotropes of carbon, as reinforcing agents in polymer structures.

It has been postulated that CNTs may have greater affinity, and therefore potential to improve strength, in unsaturated hydrocarbon-based polymer matrices, rather than saturated systems. Early studies by Qian et. al., Applied Physics Letters, 2000: 76(20), p. 2868-2870 confirmed that addition of relatively low amounts of CNTs to the unsaturated polystyrene polymer matrix led to significant improvements in tensile strength and stiffness and has contributed to the desire to incorporate CNTs into other polymer systems.

There are numerous publications relating to the utility of nanoparticles as reinforcing agents for various thermoplastic polymers but relatively few relating to the utility of nanocarbon in unsaturated hydrocarbon-based polymer natural rubber (NR), cispolyisoprene.

It is thought that the combination of the specific nature of natural rubber latex, and in particular its inherent high viscosity, and the difficulties associated with delivering nanocarbon in particulate form into the desired mixing environment have made effective incorporation, also referred to as dispersion, of nanocarbon into natural rubber a challenge. Thus it would be desirable to provide rubber compositions having nanocarbon (NC) dispersed within the rubber component thereof.

Carbon black is known for use as reinforcing filler for elastomeric rubber bearings to increase dampening effects and increasing the proportion of carbon black enhances the effect of the shear strain amplitude with desirable reductions in building vibrations due to wind force or minor earthquakes. Carbon black is now commonly used as a reinforcing agents, or filler, to improve the tensile strength and mechanical properties of rubber products, and in particular rubber for use in seismic isolation bearings. However, as reported by Carretero-Gonzalez et al., “Effect of Nanoclay an Natural Rubber Microstructure”, Macromolecules, 41 (2008), p 6763, use of large amounts of such mineral fillers can lead to heavy final products and replacement with nanoparticles may have advantages for filler distribution within the rubber.

It has also been proposed that nanomaterials, such as CNTs, may have potential as replacement mineral fillers because of their small size, high surface area and excellent aspect ratio. Abdul-Lateef et al., “Effect of MWSTs on the Mechanical and Thermal Properties of NR”, The Arabian Journal for Science and Engineering, Val 35, No. 1 C, (2010), p 49, reported that tensile strength, elasticity and toughness in rubber products were linearly improved with increasing levels of CNT.

It is an object of at least one aspect of the present invention to obviate or mitigate at least one or more of the aforementioned problems.

It is an object of at least one aspect of the present invention to provide improved natural rubber compositions for use in engineered rubber products for civil and mechanical engineering applications having nanocarbon and carbon black as reinforcing agents.

It is a further object of at least one aspect of the present invention to provide improved natural rubber compositions for use in engineered rubber products for civil and mechanical engineering applications which are lighter and which retain the desirable strength and hardness properties necessary for utility in the civil and mechanical engineering fields.

It is a yet further object of at least one aspect of the present invention to provide improved natural rubber compositions for use in engineered rubber products for civil and mechanical engineering applications having desirable strength and hardness properties in combination with processing safety and desirable optimum cure times.

### SUMMARY OF THE INVENTION

The Applicant has developed a novel rubber composition for use in engineered rubber products for use in civil and mechanical engineering applications, including use in bearings and marine fenders, having nanocarbon and carbon black as reinforcing agents which includes a specific ratio of rubber:nanocarbon:carbon black wherein the nanocarbon is uniformly pre-dispersed within the rubber component.

The rubber compositions for use in engineered rubber products for use in civil and mechanical applications developed by the Applicant provide: improved processing safety via longer cure on-set time (t2); longer optimum cure time (t95) and delayed onset of reversion; improved ageing resistance performance; and desirable physical properties such as tensile strength, hardness, elasticity, compression set and the like.

Until recently it had not been possible to fully explore and exploit the potential of nanocarbon as a rubber reinforcing agent due to dispersion associated difficulties in processing. The Applicant has developed a process for the provision of masterbatches comprising nanocarbon pre-dispersed in rubber. The improved rubber compositions for use to the present invention utilize such masterbatches for the rubber and nanocarbon components.

Thus, according to a first aspect of the present invention there is provided use of rubber compositions for use in engineered rubber products for use in civil and mechanical engineering applications wherein the rubber composition comprises a mixture of natural rubber, nanocarbon and carbon black wherein the relative amount in parts per hundred rubber (pphr) of nanocarbon to carbon black is in the range of about 1:40 to about 1:2 and the relative amount in parts per hundred rubber (pphr) of nanocarbon to natural rubber is in the range of about 1:100 to about 10:100 and wherein the nanocarbon component is predispersed within the natural rubber component.

The relative ratio of nanocarbon to carbon black may be in the range of any of the following: about 1:30 to about 1:3; about 1:20 to about 1:5 or about 1:18 to about 1:6.

The relative ratio of nanocarbon to natural rubber may be in the range of any of the following: about 1:100 to about 8:100; about 2:100 to about 6:100; about 2:100 to about 5:100.

The rubber component may contain from about 1 to 10, about 1 to 8, about 1 to 6, about 3 to 5, or about 5 pphr nanocarbon.

The carbon black may be present at a level of from about 10 to 50 or about 20 to 40 pphr.

As illustrated in the Examples hereinafter rubber compositions developed by the Applicant for use in engineered rubber products have been demonstrated to deliver improvements in aging resistance, improved processing safety and reduced reversion during processing, as well as providing desirable strength, hardness and elasticity, when compared to conventional rubber compositions, by utilizing particular mixtures of nanocarbon, uniformly pre-dispersed within natural rubber, and carbon black as reinforcing agents.

Thus, according to a further aspect the present invention provides use of rubber compositions in engineered rubber products for use in civil and mechanical engineering applications wherein the relative amount in parts per hundred rubber (pphr) of nanocarbon to carbon black is in the range of about 1:10 to about 1:2 and the relative amount in parts per hundred rubber (pphr) of nanocarbon to natural rubber is in the range of about 1:50 to about 1:10 and wherein the nanocarbon component is pre-dispersed within the natural rubber component.

The relative ratio of nanocarbon to carbon black may be in the range of any of the following: about 1:3 to about 1:2; about 1:6 to about 1:3 or about 1:5 to about 1:4.

The relative ratio of nanocarbon to natural rubber may be in the range of any of the following: about 1:40 to about 1:12, about 1:30 to about 1:15; about 1:25 to about 1:20.

The rubber component may contain from about 1 to 10, about 1 to 8, about 1 to 6, about 3 to 5, or about 5 pphr nanocarbon.

The carbon black may be present at a level of from about 15 to 35, about 15 to 30, or about 20 to 25 pphr carbon black.

### DETAILED DESCRIPTION

Engineered rubber products as defined herein are elastomeric engineered rubber products. Such engineered rubber products may be articles of sale in their own right, or may be included as component parts within larger articles. Compositions of the present invention may be used to form engineered rubber products for a variety of civil and mechanical engineering applications, as well as mining applications, such products including: bridge bearings; seismic bearings; fendering systems; wear panels; buffers; vibration isolators; seismic mounts; and critical suspension components.

Civil and mechanical applications within which the engineered rubber products as defined herein can be utilized include: marine fendering or docking systems; small vessel mooring; lock-up devices to absorb large loads; tuned mass and/or viscous dampers; road engineering, bridge bearings; critical suspension components for mining; rail, truck and heavy equipment; earthquake and seismic bearings for isolation of civil engineering structures from earthquakes (base isolation) via seismic isolation of buildings, bridges and the like; vibration isolators and dampeners such as heavy-duty isolators for building systems and industrial utility such as mechanical springs and spring-dampeners; elastomeric rubber shock absorbers isolators and/or mounts for use in machinery mounts or in vehicles.

Bridge bearings are devices for transferring loads and movements from bridge decks to supporting piers. According to a yet further aspect the present invention provides rubber compositions for use in rubber marine fenders. Both static fendering and docking systems to prevent damage to large craft and berthing structures, or to docks and marine structures such as canal entrances and bridge bases, as well as mobile fendering or docking systems suitable for small leisure craft and support vessels may be made from said compositions and are included within the definition rubber marine fenders herein.

According to a yet further aspect the present invention provides rubber compositions for use in engineered rubber products wherein said products are rubber marine fenders.

According to a yet further aspect the present invention provides rubber compositions for use in engineered rubber products wherein said products are seismic bearings.

Critical suspension components for rail, truck and heavy equipment as defined herein includes: vibration isolators, engine mounts, transmission mounts, and mass dampers. According to a yet further aspect the present invention provides rubber compositions for in engineered rubber products wherein said products are independently selected from: vibration isolators; engine mounts; transmission mounts; and mass dampers.

Any natural sourced rubber product may be used in the compositions according to the invention including: unprocessed and processed latex products such as ammonia containing latex concentrates; RSS, ADS or crepes; TSR, SMR L, SMR CV; or specialty rubbers SP, MG, DP NR; or field grade (cup lump) rubber products such as TSR, SMR 10, SMR 20, SMR 10 CV, SMR 20 SV, SMR GP and SMR CV60. Further examples of natural rubbers suitable for use herein include chemically modified natural rubber products including: epoxidized natural rubbers (ENRs) such as for example ENR 25 and ENR 50. For the avoidance of doubt, all references to rubber in relation to the compositions according to the invention are to natural rubber as defined herein.

Preferred for use in the compositions herein are rubbers from a masterbatch having a pre-determined amount of nanocarbon pre-dispersed therein wherein the rubber is produced from a latex concentrate such as for example high ammonia natural rubber (HA NR) or low ammonia natural rubber (LA NR) and especially HA NR. Nanocarbon (NC) as defined herein relates to nanosized carbon structures and includes: all types of single, double, or multi-wall carbon nanotubes (CNTs) and mixtures thereof; carbon nanotubes (CNTs), all types of carbon nanofibers (CNFs) including vapor grown carbon nanofibers (VGCNFs) and mixtures thereof; all types of graphite nanofibers (GNFs) including platelet graphite nanofibers (PGNFs) and mixtures thereof; and mixtures of different nanosized carbon structures. CNTs or GNFs suitable for use herein include for example helical, linear or branched type. VGCNFs suitable for use herein are cylindrical nanostructures with grapheme layers arranged as stacked cones, cups or plates.

Any nanocarbon (NC) as defined herein may be used for the preparation of a rubbernanocarbon masterbatch according to the process outlined hereinafter. CNTs, VGCNFs and PGNFs are preferred. CNTs having a length of <50 μm and/or an outer diameter of <20 nm are preferred and especially CNTs having a C-purity of >85% and non-detectable levels of free amorphous carbon. The concentration of nanocarbon, and in particular CNT, VGCNF or PGNF, pre-dispersed in the natural rubber masterbatch may preferably be about 5 g or less of nanocarbon per 100 g of rubber. In other words the masterbatch may preferably contain no more than about 5 parts by weight (pphr) nanocarbon per 100 parts by weight of rubber. Masterbatches suitable for use herein may, for example, include from about 2 to about 5 pphr nanocarbon. Preferred masterbatches for use may herein include: from about 2 to about 5 pphr CNT, preferably from about 2.5 to about 4.5 pphr CNT, more preferably from about 3 to about 4 pphr CNT; from about 2 to about 5 pphr PGNF, preferably from about 3 to about 5 pphr PGNF, more preferably from about 4 to about 5 pphr PGNF; and mixtures thereof. Particularly preferred masterbatches include about 5 pphr CNT or about 5 pphr VGCNF.

Thus the present invention provides rubber compositions for use in engineered rubber products for use in civil and mechanical engineering applications having nanocarbon and carbon black as reinforcing agents wherein the relative amount in parts per hundred rubber (pphr) of nanocarbon to carbon black is in the range of about from about 1:40 to about 1:2 and the relative amount in parts per hundred rubber (pphr) of nanocarbon to natural rubber is in the range of from about 1:100 to about 10:100 and wherein the nanocarbon component is pre-dispersed within the natural rubber component wherein the rubber is produced from a HA NR latex concentrate.

According to a further aspect the present invention provides rubber compositions for use in engineered rubber products for use in civil and mechanical engineering applications having nanocarbon and carbon black as reinforcing agents wherein the relative amount in parts per hundred rubber (pphr) of nanocarbon to carbon black is in the range of about 1:10 to about 1:2 and the relative amount in parts per hundred rubber (pphr) of nanocarbon to natural rubber is in the range of about 1:50 to about 1:10 and wherein the nanocarbon component is pre-dispersed within the natural rubber component and wherein the rubber is produced from a HA NR latex concentrate, and preferably wherein the relative ratio of nanocarbon to carbon black may be in the range of any of the following: about 1:3 to about 1:2; about 1:6 to about 1:3 or about 1:5 to about 1:4.

Where the relative amount in parts per hundred rubber (pphr) of nanocarbon to natural rubber is in the range of about 1:50 to about 1:10 and wherein the nanocarbon component is pre-dispersed within the natural rubber component the rubber is produced from a HA NR latex concentrate, and wherein the relative ratio of nanocarbon to carbon black is in the range of any of the following: about 1:3 to about 1:2; about 1:6 to about 1:3 or about 1:5 to about 1:4 the rubber component may contain from about 1 to 10, about 1 to 8, about 1 to 6, about 3 to 5, or about 5 pphr nanocarbon, and preferably wherein the relative ratio of nanocarbon to natural rubber may be in the range of any of the following: about 1:40 to about 1:12, about 1:35 to about 1:15; about 1:25 to about 1:20.

Where the relative ratio of nanocarbon to natural rubber is in the range of any of the following: about 1:40 to about 1:12, about 1:35 to about 1:15; about 1:25 to about 1:20 as detailed hereinbefore the carbon black may be present at a level of from about 15 to 35, about 15 to 30, or about 20 to 25 pphr carbon black.

Typically, the nanocarbon may be pre-dispersed into the natural rubber according to the process described in Patent Application PCT/MY2012/000221, the disclosures of which are incorporated herein by reference and in particular according to the specific process described at Example 1 (which is reproduced herein as Process Example).

Thus according to a second aspect of the present invention there is provided rubber compositions for use in engineered rubber products for civil and mechanical engineering applications having nanocarbon and carbon black as reinforcing agents wherein the relative amount in parts per hundred rubber (pphr) of nanocarbon to carbon black is in the range of about from about 1:40 to about 1:2 and the relative amount in parts per hundred rubber (pphr) of nanocarbon to natural rubber is in the range of from about 1:100 to about 10:100 and wherein the nanocarbon component is pre-dispersed within the natural rubber component and wherein said rubber component is from a masterbatch produced via:
(a) formation of an aqueous slurry containing a dispersion of nanocarbon, at a level of from about 2% to 10% by weight of the aqueous slurry, and a surfactant and optionally a stabilizer;
(b) grinding of the aqueous nanocarbon containing slurry;
(c) combination of the aqueous slurry with a natural rubber latex concentrate or diluted latex solution and mixing until a uniform mixture is obtained;
(d) coagulation of the mixture followed by aqueous washing, and removal of excess surfactant, water and excess optional stabilizers by coagulate squeezing or suitable alternative method; and
(e) formation of dried rubber nanocarbon masterbatches by either direct drying of the coagulate from step (d) or by coagulate cutting to granulate size and subsequent drying
wherein the pH of the slurry and latex are similar or equivalent prior to combination, and wherein the pH of the nanocarbon is capable of being adjusted using a suitable base to align it to the pH of the rubber latex.

According to a yet further aspect, the rubber compositions for use according to the invention comprising nanocarbon component pre-dispersed within the natural rubber component from masterbatches prepared according the process as defined hereinbefore include nanocarbon and carbon black as reinforcing agents wherein the relative amount in parts per hundred rubber (pphr) of nanocarbon to carbon black is in the range of about 1:10 to about 1:2 and the relative amount in parts per hundred rubber (pphr) of nanocarbon to natural rubber is in the range of about 1:50 to about 1:10.

Typically, the pH of the slurry and latex may be within about 2, 1 or 0.5 pH units prior to combination.

Moreover, the formation of the aqueous slurry may contain a dispersion of nanocarbon at a level of from about 3% to about 5% by weight of the aqueous slurry and a surfactant and optionally a stabilizer.

Any carbon black suitable for reinforcing natural rubber may be used in the rubber compositions for use according to the invention. Examples of suitable carbon black include: super abrasion furnace (SAF N11 O); intermediate super abrasion furnace (ISAF) N220; high abrasion furnace (HAF N330); easy processing channel (EPC N300); fast extruding furnace (FEF N550); high modulus furnace (HMF N683); semi-reinforcing furnace (SRF N770); fine thermal (FT N880); and medium thermal (MT N990).

Carbon black may be included at a level of from about 10 pphr to 50 pphr; 20 pphr to 40 pphr, preferably from 25 pphr to 35 pphr and preferably from 30 pphr to 35 pphr in compositions according to the invention. ISAF N220 is a preferred form of carbon black for use in compositions according to the invention. The Applicant has found that rubber compositions for use according to the invention, and as demonstrated in the Examples hereinafter, are capable of delivering both improvements in key processing attributes, such as for example cure time, as well as improvements in highly desirable performance attributes, such as for example aging resistance, ozone cracking, tensile strength, hardness, elongation at break and band strength in comparison to a Formulation having far higher carbon black components. In particular, the compositions of the invention include carbon black at from about 10% to less than about 40%, and preferably from about 15% to about 35% and more preferably from about 20% to about 25% of carbon black to 100% of rubber.

The Applicant has also found that particular combinations of reinforcing agents are valuable for the delivery of desirable properties in the compositions according to the invention. Such combinations are illustrated in the Examples hereinafter.

For the avoidance of doubt where amounts of any materials or components are referred to herein as pphr this means parts per hundred rubber.

Further agents which may be incorporated into the rubber compositions include any one or more of the following: one or more curing agents; one or more activators; one or more delayed-accelerators; one or more antioxidants; one or more processing oils; one or more waxes; one or more scorch inhibiting agents; one or more processing aids; one or more tackifying resins; one or more reinforcing resins; one or more peptizers, and mixtures thereof.

Examples of suitable vulcanization agents for inclusion to the rubber compositions of the invention include sulphur or other equivalent “curatives”. Vulcanizing agents, also referred to as curing agents, or sometimes referred to as cross linkers, modify the polymeric material (polyisoprene) in the natural rubber containing component to convert it into a more durable material for commercial utility, and may be included at a level of from about 1 pphr to about 4 pphr, preferably from about 1 pphr to about 3 pphr and preferably from about 1.5 pphr to about 2.5 pphr in formulations according to the invention. Sulphur is the preferred vulcanizing agent for incorporation into the compositions according to the invention.

Examples of suitable vulcanizing activating agents for inclusion to the rubber compositions of the invention include zinc oxide (ZnO), stearic acid (octadecanoic acid), stearic acid/palmitic acid mixture, or other suitable alternatives. It is thought that vulcanizing activating agents essentially accelerate the rate of vulcanization. Activators and coactivators are essential materials to enhance activation (initiation) of the vulcanization process. Vulcanizing activating agents can be included at a total level of from about 2 pphr to about 10 pphr, preferably from about 3 pphr to about 7 pphr and preferably from about 4 pphr to about 6 pphr. Zinc oxide and stearic acid are preferred vulcanizing activating agents for incorporation into the compositions according to the invention at individual levels of zinc oxide at a level of from about 1.5 pphr to about 8 pphr, preferably from about 2 pphr to about 6 pphr and preferably about 5 pphr and stearic acid at from about 0.5 pphr to about 4 pphr, preferably from about 1 pphr to about 3 pphr and preferably about 2 pphr.

Examples of suitable vulcanizing delayed-accelerators for inclusion in the rubber compositions of the invention include any one of or combination of the following: Ncyclhexyl-2-benzolthiazole sulfenamide (CBS); N-tertiary-butyl-benzothiazole-sulphenamide (TBBS); 2-Mercaptobenzothiazole (MBT); 2.2′-Dibenzothiazole Disulfide (MBTS); 2-(2,4-Dinitrophenylthio) benzothiazole (DNBT); Diphenylguanidine (DPG); Diethyldiphenylthiuram disulphide; Tetramethylthiuram disulphide; Tetramethyl Thiuram Monosulfide (TMTM); N,Ndicyclohexyl-2-benzothiazole sulfenamide (DCBS); N-oxydiethylene thiocarbamyl-N′oxydiethylene sulphenamide (OTOS) and the like. It is thought that vulcanizing delayed accelerators essentially assist the vulcanization process by increasing the vulcanization rate at higher temperatures. Vulcanizing delayed-accelerators can be included at a level of from about 0.5 pphr to about 3 pphr, preferably about 1 pphr to about 2 pphr, and especially about 1.5 pphr. CBS is preferred as a vulcanizing delayed-accelerator for incorporation into the compositions according to the invention.

Antioxidants, which provide protection against oxidation and heat aging, and antiozonants, which provide protection against ozone cracking and flex cracking, can be generally considered to be chemicals which are included into the composition to impart protection against, or improved resistance to surface attack, or surface degradation. Examples of suitable antiozonants for inclusion to the rubber compositions of the invention include any one of or combination of the following: N-(1,3-dimethylbutyl)-N-phenyl-phenylenediamine (6PPD); 2-mercaptobenzimidazole compounds; 2-benzimidazolethiol; Dialkylated diphenylamines; octylated diphenylamine; Nickel dibutyldithiocarbamate; Nisopropyl-N′-phenyl-p-phenylene diamine; 4′-diphenyl-isopropyl-dianiline; 2,2′-Methylenebis(6-tert-butyl-4-methylphenol); paraffin waxes such as Antiflux 654.

Individual antioxidants and antiozonants can be included at a level of from about 0.5 pphr to about 5 pphr, preferably from about 2 pphr to about 4 pphr, and especially about 3 pphr. A combination of antioxidants can be included at a combined level of from 1 pphr to about 10 pphr, preferably from about 4 pphr to about 8 pphr, and especially about 6 pphr. 6PPD and Antiflux 654 are preferred as antioxidants in the compositions according to the invention, and particularly preferred in combination at a level of about 3 pphr each.

Examples of suitable processing oils for inclusion in the rubber compositions of the invention include: Nytex 840; napthanlenic oils such as Shellflex 250 MB. Processing oils can be included at a level of from about 2 pphr to about 6 pphr, preferably from about 3 pphr to about 5 pphr, and especially from about 4 pphr to about 4.5 pphr. Nytex 840 is preferred as processing oil in the compositions according to the invention. Alternative oils having comparable properties to Nytex 840 may alternatively be included.

Examples of suitable optional additional reinforcing agents for inclusion in the rubber compositions of the invention include one or more silicas, silanes and/or clays, such as for example: silicas commercially available from PPG Industries under the Hi-Sil trademark with designations 210, 243, etc; silicas available from Rhodia, with, for example, designations of Z1165MP and Z165GR and silicas available from Degussa AG with, for example, designations VN2, VN3, VN3 GR; silanes commercially available from Evonik such as Si 363® and Si 69® (Bis[3-(triethoxysilyl)propyl]tetrasulfide). Where an optional, additional silica based reinforcing agent is used then a suitable coupling agent, such as a silane may also be included.

Additional agents which can be included into the compositions also include peptizers (e.g. AP—zinc Pentachlorobenzenethiol zinc, WP-1, HP).

The rubber compositions for use in engineered rubber products for use in civil and mechanical engineering applications according to the present invention may be used in a range of applications such as in bearings, fendering systems and vibration isolators or shock absorbers. In particular rubber compositions for use in engineered rubber products for use in civil and mechanical engineering applications according to the present invention may be independently used in rubber bridge bearings, rubber seismic bearings, and marine or docking fendering systems.

### DETAILED DESCRIPTION

### Experimental Methods

The various physical properties of the compositions exemplified can be measured according to any of the standard methodologies as are known in the art. For example, onset of vulcanization can be detected via an increase in viscosity as measured with a Mooney viscometer (Vc). These measurements can be made according to various internationally accepted standard methods ASTM 01616-07(2012) (http://www.astm.org/Standards/01646.htm). Density (specific gravity), elasticity (M100, M300) and tensile strength as measurable according to ASTM D412-06ae2 (http://www.astm.org/Standards/0412.htm), or http://info.admet.com/specifications/bid/34241/ASTM-0412-Tensile-Strength-Properties-of-Rubber-and-Elastomers. Elongation at break (EB) as measurable by the method described in http://www.scribd.com/doc/42956316/Rubber-Testing or in http://harboro.eo.uk/measurement of rubber properties.html where alternative methods for measurement of tensile strength, compression set, density, ozone resistance, accelerated aging and band strength are also provided. Hardness (International Rubber Hardness Degree, IRHD), as measured according to ASTM 01415-06(2012) (http://www.astm.org/Standards/01415.htm). Compression set as measured according to ASTM 0395-03(2008) (http://www.astm.org/Standards/D395.htm). Bond strength measured according to ASTM 0429-08 (http://www.astm.or.Q/Standards/D429.htm). Ageing resistance and ozone cracking as measurable by the methods described in ASTM 0572-04(2010) (http://www.astm.org/Standards/0572.htm), and ASTM 04575-09 (http://www.astm.org/Standards/04575.htm) respectively.

### Process Example

### Part 1

### Preparation of Nanocarbon Slurry and Nanocarbon Dispersion

A 1% nanocarbon dispersion was prepared as follows: 3 g of nanocarbon was put into a glass beaker (500 ml) containing 15 g of a surfactant and 282 g of distilled water. The mixture was stirred by means of mechanical stirrer at 80 rpm for about 10 minutes to obtain a nanocarbon slurry. The slurry was transferred to a ball mill for grinding to break down any agglomerates of nanocarbon. Ball milling was done for 24 hours to obtain a nanocarbon dispersion, which was then transferred into a plastic container. The surfactant was used in the form of a 10% to 20% solution.

In an analogous manner, a 3% nanocarbon dispersion was prepared from 9 g of nanocarbon, 45 g of surfactant and 246 g of distilled water. The pH of dispersion was adjusted (by adding KOH) to that of the latex to which it was to be added.

### Part 2

### Preparation of Nanocarbon-Containing Natural Rubber Master Batches

The nanocarbon dispersion prepared as described above was mixed with high ammonia natural rubber latex concentrate (HA NR latex). The latex concentrate was first diluted with distilled water to reduce its concentration in order to reduce the viscosity of the latex to facilitate mixing with the nanocarbon dispersion. The mixing with the nanocarbon dispersion was then done in the presence of about 5 pphr of surfactant (employed as a 5% to 20% solution).

The nanocarbon dispersion and the surfactant were discharged into a beaker containing the natural rubber (NR) latex. The mixture was subjected to mechanical stirring. The NR latex was then coagulated with acetic acid. The coagulum formed was washed with water and squeezed to remove excess surfactants and water. The coagulum was cut into small granules and washed with water. These granules were then dried in an electrically heated oven until they were fully dried to obtain a nanocarbon-containing natural rubber masterbatch.

The amount of nanocarbon in the dispersion and the amount of the dispersion and the latex are chosen so as to obtain a predetermined ratio of nanocarbon to rubber (expressed herein in terms of pphr). More specifically the masterbatch contained 2 pphr of nanocarbon.

The following non-limiting examples are representative of the rubber compositions for use according to the present invention.

### Example Formulations 1 to 4

Formulations 1 to 4 are suitable for use in compounding formulations for elastomeric engineered rubber products for use in bridge and marine fendering systems.

Formulations 2 to 4 are representative of the compositions for use according to the invention and formulation 1 is a comparative example based upon a commercially available Standard Malaysian Rubber (SMR CV60). All components are expressed as pphr rubber, for example CNT MB 105 means that there are 5 pphr of CNT in 100 parts of rubber masterbatch MB (dried NR latex) and stearic acid “2” means that there are 2 parts of stearic acid per 100 parts of rubber.

| Ingredients | 1 | 2 | 3 | 4 |
|---|---|---|---|---|
| Rubber, SMR CV60 | 100 | — | — | — |
| Rubber-CNT MB (VGCNF) | — | ¹105 | — | — |
| Rubber-CNT MB (C-70P) | — | — | ²105 | — |
| Rubber-CNT MB (C-100) | — | — | — | ³105 |
| Activator, Zinc oxide | 5 | 5 | 5 | 5 |
| Activator, Stearic acid | 2 | 2 | 2 | 2 |
| Antioxidant, 6PPD | 3 | 3 | 3 | 3 |
| Carbon Black, N330 | 42 | 20 | 20 | 25 |
| Oil, Dutrex 737 | 4.2 | 4.2 | 4.2 | 4.2 |
| Ingredients | 1 | 2 | 3 | 4 |
| Accelerator, CBS | 1.5 | 1.5 | 1.5 | 1.5 |
| Curing Agent, Sulfur | 1.5 | 1.5 | 1.5 | 1.5 |
| Antiozonant, Antiflux 654 | 3 | 3 | 3 | 3 |

Carbon nanotubes have a length of <50 μm and an outer diameter of <20 nm; a C-purity of >85% and non-detectable free amorphous carbon. Employed as supplied i.e. as agglomerated bundles of CNTs with average dimensions of 0.05 to 1.5 mm.
1 Vapor grown carbon nanofibers (VGCNF) are graphene layers wrapped into cylinders, carbon nanotubes (CNTs).
2 Available from Bayer Material Science, C-70P
3 Available from Bayer Material Science, C-100

### Experimental Results

As illustrated in Table 1, the rubber compositions for use according to the invention, Examples 2 to 4, have longer t2 (scorch time) and longer t95 (cure time) times than comparative example formulation 1. These results demonstrate both the improved processing safety for the compositions for use according to the invention as well as their delayed onset of reversion. The longer optimum cure time t95 is a particular advantage since it delays the onset or reversion which is especially important in the curing of thick rubber products such as seismic rubber bearings.

TABLE 1

| Properties related to Curing | 1 | 2 | 3 | 4 |
|---|---|---|---|---|
| Scorch time, t2 (minutes) at | 3.37 | 3.52 | 4.1 | 4.13 |
| 150° C. | | | | |
| Cure time, t95 (minutes) at 150° C. | 8.32 | 12.08 | 12.1 | 12.31 |

Table 2 illustrates the desirable physical characteristics for the rubber compositions for use according to the invention, in particular Table 1 shows that Example compositions 2 to 4 all meet the specification for rubber bridge bearings MS671 (1991). As particularly illustrated in Table 2, all cured formulations for use according to the invention demonstrated improved hardness versus comparator formulation 1, and, cured formulations for use according to the invention demonstrated improved strength and compression properties, when compared to comparator formulation 1.

TABLE 2

| Material Property | 1 | 2 | 3 | 4 | MS671 | MS1385 | Doshin |
|---|---|---|---|---|---|---|---|
| Tensile Strength (MPa) | 28.3 | 26.4 | 26.2 | 28.7 | 15.5 | 16 | 12 |
| Elongation at break, EB | 600 | 571 | 567 | 616 | 400 | 350 | 400 |
| (%) | | | | | | | |
| Hardness (IRHD) | 60 | 68 | 63 | 66 | 60 ± 5 | 65 | 60 ± 5 |
| Compression set | 24.3 | 29.1 | 23.4 | 24.2 | 30 | 30 | 25 |
| 24 h/70° C., (%) | | | | | | | (max) |
| Bond strength (N/mm) | 10.1 | 13.4 | 5.4 (RC - | 14.03 | 9 | nil | 9 |
| | | | rubber- | | | | |
| | | | to- | | | | |
| | | | cement- | | | | |
| | | | failure) | | | | |

Ultimate tensile strength, or simply tensile strength, is the maximum force the rubber can withstand without fracturing when stretched, and provides an indication of how strong a rubber composition is.

Compression set is an important property of elastomeric engineered rubber products since is measures the ability of rubber to return to its original thickness after prolonged compressive stresses at a given temperature and deflections. Compression set results are expressed as a percentage maximum figure, the lower the percentage figure the better the material resists permanent deformation under a given deflection and temperature range.

Compressive strength is the opposite of tensile. Thus it is necessary to develop elastomeric engineered rubber products which deliver an appropriate balance between opposing parameters in order to be suitable for use according to the invention. Industry standard measurement sets such as MS671 (1991), referred to hereinafter as MS671, for rubber bridge bearings and MS1385 (2010), referred to hereinafter as MS1385 for marine fenders, and Doshin Rubber, for seismic rubber bearings, referred hereinafter as Doshin all provide qualifying parameters for material properties for particular utilities. All example Formulations 2 to 4 demonstrated tensile strengths in excess of the minimal levels required under MS671, MS 1385 and Doshin, and Formulation 4 had improved tensile strength versus comparator formulation 1. All example Formulations 2 to 4 demonstrated compressive set data within the level required under MS671, MS1385 and Doshin, and Formulation 3 had improved (lower) compression set versus comparator formulation 1.

Indentation hardness (IRHD) is a measurement of how resistant the material is to applied force. Formulations 2 to 4 all demonstrated improved IRHD versus comparator formulation 1 and in excess of the levels required for MS671, MS1385 and Doshin. Elongation at break (EB), with respect to tensile strength testing, is a measurement of how much a sample will stretch prior to break and us usually expressed as a percentage i.e. the maximum elongation. All example Formulations 2 to 4 demonstrated EB in excess of the minimal levels required under MS671, MS1385 and Doshin, and Formulation 4 had improved EB versus comparator formulation 1.

Example Formulations 2 and 4 demonstrated band strengths in excess of the minimal levels required under MS671, as well as improved band strength versus comparator formulation 1.

In addition to the required physical parameters necessary to demonstrate initial suitability of a rubber composition for potential utility within an elastomeric engineered rubber product for use according to the invention, it is highly desirable that rubber compositions demonstrate resistance to ageing, and in particular resistance to the effects of ozone.

As illustrated in Table 3, formulations for use in accordance with the invention display desirable properties after accelerated aging in air. All the test formulations were subjected to accelerated ageing for 7 days at 70° C.

TABLE 3

| | | | | | MS671 (% | MS1385 (% | Doshin (% |
|---|---|---|---|---|---|---|---|
| | | | | | Maximum | Maximum | Maximum |
| Property | 1 | 2 | 3 | 4 | decrease) | decrease) | decrease) |
| Change in | −0.7 | −1.5 | 0 | −1.7 | −15 | −20 | ±15 |
| tensile strength, | | | | | | | |
| (%) | | | | | | | |
| Measured | 28.0 | 26.0 | 26.2 | 28.2 | — | — | — |
| change in | | | | | | | |
| tensile strength, | | | | | | | |
| (MPa) | | | | | | | |
| Change in EB | −6 | −1.8 | −3.7 | −9 | −20 | −20 | ±20 |
| (%) | | | | | | | |
| Ozone | No | No | No | No | No visible | No visible | No visible |
| resistance 48 h at | crack | crack | crack | crack | crack under | crack under | crack under |
| 50 pphm (O₃), | | | | | 7× | 7× | 7× |
| 40° C., 20% | | | | | magnification | magnification | magnification |
| strain | | | | | | | |

The example formulations demonstrated excellent aging resistance overall and in particular in relation to the low changes in tensile strength and elongation at break observed, which, at less than 2% and less than 10% respectively compare most favorably versus the requirements of MS671, MS1385 and Doshin.

Ozone resistance, measures whether visible cracking is observed over test conditions and is important as it indicates how well a composition will behave in its environment of use. All example formulations 2 to 4 demonstrated desirable ozone resistance which demonstrates that the antiozonant protection system within the formulations tested was good.

All example formulations 2 to 4 have been demonstrated to meet the requirements for utility in rubber bridge bearings. Example formulations 2 and 4 were demonstrated to meet the requirements for utility in marine fenders. Furthermore, it is anticipated that the hardness requirement for marine fenders will be satisfied by modification of example formulation 3 to an increased level of CNT. Example formulation 4 has also been demonstrated to meet the requirement for utility in seismic rubber bearings.

Whilst specific embodiments of the present invention have been described above, it will be appreciated that departures from the described embodiments may still fall within the scope of the present invention. For example, any suitable type of nanoparticle and carbon black may be used. Moreover, any type of natural rubber may be used.

1. A rubber composition for use in the manufacture of engineered products for civil and mechanical engineering applications wherein said rubber composition comprises a mixture of natural rubber, nanocarbon and carbon black wherein the relative amount in parts per hundred rubber (pphr) of nanocarbon to carbon black is in the range of about 1:40 to about 1:2 and the relative amount in parts per hundred rubber (pphr) of nanocarbon to natural rubber is in the range of about 1:100 to about 10:100 and wherein the nanocarbon component is pre-dispersed within the natural rubber component.

2. The rubber composition according to claim 1, wherein the relative ratio of nanocarbon to carbon black in pphr is in the range of any of the following: about 1:30 to about 1:3; about 1:20 to about 1:5 or about 1:18 to about 1:6.

3. The rubber composition according to claim 1, wherein the relative ratio of nanocarbon to natural rubber in pphr is in the range of any of the following: about 1:100 to about 8:100.

4. The rubber composition according to claim 1, wherein the rubber component contains from about 1 to 10 pphr nanocarbon.

5. The rubber composition according to claim 1, wherein carbon black is 25 percent at a level of from about 10 to 50 pphr.

6. A rubber composition for use in the manufacture of engineered products for civil and mechanical engineering applications wherein said rubber composition comprises a mixture of natural rubber, nanocarbon and carbon black wherein the relative amount in parts per hundred rubber (pphr) of nanocarbon to carbon black is in the range of about 1:10 to about 1:2 and the relative amount in parts per hundred rubber (pphr) of nanocarbon to natural rubber is in the range of about 1:50 to about 1:1 wherein the nanocarbon component is pre-dispersed within the natural rubber component.

7. The rubber composition according to claim 6, wherein the relative ratio of nanocarbon to carbon black in pphr is in the range of from about 1:3 to about 1:2.

8. A rubber composition according to claim 6, wherein the relative ratio of nanocarbon to natural rubber in pphr is in the range of from about 1:40 to about 1:12.

9. A rubber composition according to claim 6, wherein the rubber component contains from about 1 to 10 pphr nanocarbon.

10. A rubber composition according to claim 6, wherein carbon black is present at a level of from about 15 to about 35 pphr.

11. A rubber composition according to claim 1, wherein the natural rubber is selected from any one of or combination of the following: unprocessed and processed latex products such as ammonia containing latex concentrates; RSS, ADS or crepes; TSR, SMR L, SMR CV; specialty rubbers SP, MG, DP NR; or field grade (cup lump) rubber products such as TSR, SMR 10, SMR 20, SMR 10 CV, SMR 20 SV, SMR GP, SMR CV60.

12. A rubber composition according to claim 1, wherein the natural rubber is selected from chemically modified natural rubber products including: epoxidized natural rubbers (ENRs) such as ENR 25 and ENR 50.

13. A rubber composition according to claim 1 containing a vulcanizing agent.

14. A rubber composition according to claim 1 containing one or more vulcanizing delaying accelerators.

15. A composition according to claim 1 containing one or more vulcanizing activating agents.

16. A rubber composition according to claim 1 containing one or more antioxidants.

17. The use of a rubber composition as defined in claim 1 in bridge bearings.

18. The use of a rubber composition as defined in claim 1 in seismic bearings.

19. The use of a rubber composition as defined in claim 1 in marine fendering systems.
